(19) United States
(12) Patent Application Publication
(10) Pub. No.: US 2026/0266392 A1
(43) Pub. Date: Sep. 10, 2026

(54) CONNECTOR WITH SELF-LOCKING FUNCTION

(71) Applicant: Dongguan Jijia Thermal Control Technology Co., Ltd., Dongguan (CN)

(72) Inventors: Ronghua LIU, Dongguan (CN); Xingxing HUANG, Dongguan (CN)

(73) Assignee: Dongguan Jijia Thermal Control Technology Co., Ltd., Dongguan (CN)

(21) Appl. No.: 19/432,214

(22) Filed: Dec. 24, 2025

(30) Foreign Application Priority Data
Mar. 5, 2025 (CN) 202510258445.8

(51) Int. Cl. F16K 35/14; F16K 5/06; F16K 5/08

(52) U.S. Cl. CPC F16K 35/14; F16K 5/0647; F16K 5/08

(57) ABSTRACT

A connector with a self-locking function is provided. The connector with a self-locking function includes a valve body, where an interlocking assembly is disposed at a bottom of the valve body, and two distinct valve bodies are connected together via the interlocking assembly; a side wall of the valve body is rotatably connected to a handle assembly, a limiting assembly for limiting the handle assembly is further disposed on the side wall of the valve body, and rotation of the handle assembly drives rotation of a valve core within the valve body; and a tail end piece is rotatably connected to a top of the valve body. The connector provides a reliable interlock function, effectively solving problems of safety accidents caused by misoperation or system failure.

### CROSS REFERENCE TO THE RELATED APPLICATIONS

This application is based upon and claims priority to Chinese Patent Application No. 202510258445.8, filed on March 5, 2025, the entire contents of which are incorporated herein by reference.

### TECHNICAL FIELD

The present invention relates to the field of valve technology, and more particularly, to a connector with a self-locking function.

### BACKGROUND

Currently, ball valves are widely used in various fluid delivery systems. However, in certain specific scenarios, it is necessary to operate and control a plurality of ball valves to ensure the safe operation of the system. However, conventional ball valves typically operate independently and lack an effective interlocking mechanism, which may easily lead to misoperation, resulting in system failure or safety incidents.

Therefore, how to design a novel connector with a self-locking function to achieve precise interlocking between multiple ball valves, prevent misoperation, and enhance system reliability and safety has become a pressing challenge that urgently needs to be addressed by those skilled in the art.

### SUMMARY

An objective of the present invention is to provide a connector with a self-locking function, which overcomes the problems of poor reliability and low safety in existing ball valves.

To solve the above technical problem, the present invention adopts the following technical solution.

The present invention provides a connector with a self-locking function, including a valve body, wherein an interlocking assembly is disposed at a bottom of the valve body, and two distinct valve bodies are connected together via the interlocking assembly; a side wall of the valve body is rotatably connected to a handle assembly, a limiting assembly for limiting the handle assembly is further disposed on the side wall of the valve body, and rotation of the handle assembly drives rotation of a valve core within the valve body; and a tail end piece is rotatably connected to a top of the valve body.

Optionally, the interlocking assembly includes a connection slot and a hook-shaped protrusion, the connection slot is formed at the bottom of the valve body, the hook-shaped protrusion is integrally formed at the bottom of the valve body and is located surrounding the connection slot, and the hook-shaped protrusion and the connection slot are configured to engage with each other.

Optionally, a handle connector is integrally formed with the side wall of the valve body, the handle connector is provided with a first mounting passage and a second mounting passage, and a connection end of the handle assembly passes through the first mounting passage and is connected to the valve core; the second mounting passage is in communication with the connection slot, and the limiting assembly is installed within the second mounting passage;

a valve core stabilizer is further integrally formed with the side wall of the valve body, a third mounting passage is provided in the valve core stabilizer, the third mounting passage is coaxial with the first mounting passage, and a stabilizing assembly for stabilizing the valve core is installed within the third mounting passage; and

the side wall of the valve body is further provided with a wire insertion port, an inner wall of the valve body is provided with an annular groove for mounting a wire, the wire insertion port corresponds to the annular groove, and the wire is configured to limit the tail end piece.

Optionally, the handle connector is further provided with a first limiting hole and a second limiting hole for limiting the handle assembly.

Optionally, the handle assembly includes an inner knob block and an outer knob block, wherein a center of the inner knob block is provided with a protrusion, a body of the protrusion is rotatably disposed within the first mounting passage, and the protrusion is snap-fit engaged with the valve core; a bolt is threadedly connected to the inner knob block, and a body of the bolt passes through a predrilled through hole at a center of the protrusion and is threadedly connected to the valve core;

a first magnetic ring is mounted on the inner knob block, a second magnetic ring is mounted on the outer knob block, and the inner knob block and the outer knob block are magnetically coupled together via the two magnetic rings; the inner knob block is provided with a limiting screw, and the other end of the limiting screw is connected in a third limiting hole of the outer knob block; and

a first limiting pin is mounted on the outer knob block, the first limiting pin corresponds to the first limiting hole and the second limiting hole, respectively, and the inner knob block is provided with a through hole for the first limiting pin to pass through.

Optionally, the limiting assembly includes a third magnetic ring and a second limiting pin, the third magnetic ring is adhered within the second mounting passage, an iron block is mounted on a body of the second limiting pin, and the iron block is magnetically attached to the third magnetic ring; and

the inner knob block is provided with an arc-shaped groove, one end of the arc-shaped groove is connected to a limiting pin insertion port, one end of the second limiting pin is located within the connection slot, and the other end is partially embedded in the limiting pin insertion port, when two valve bodies are connected together via the interlocking assembly, the hook-shaped protrusion on one valve body displaces the second limiting pin on the other valve body out of the connection slot, thereby, an end head portion of the second limiting pin is entirely embedded within the limiting pin insertion port.

Optionally, the stabilizing assembly includes a spring and a sleeve, the sleeve is sleeved over the spring, one end of the spring abuts against an inner wall of the third mounting passage, the other end of the spring abuts against the sleeve, a main body of the sleeve is movably connected within the third mounting passage, and the sleeve is rotatably connected to the valve core.

Optionally, two O-rings for sealing are connected to the tail end piece.

Optionally, an O-ring for sealing is sleeved over each of the protrusion and the bolt.

Optionally, sealing rings are mounted at the bottom of the valve body.

Compared with the prior art, the beneficial technical effects of the present invention include:

1) In the single-unit state, the handle is prevented from driving the valve core to open, thereby avoiding misoperation.

2) The present invention provides a reliable interlocking function, effectively solving problems of safety accidents caused by misoperation or system failure.

3) The structural design is rational, and the interlocking assembly acts sensitively, capable of quickly responding to changes in the ball valve's status.

Connectors with self-locking functionality can be selected in appropriate sizes based on different application scenarios, providing high flexibility and adaptability.

### BRIEF DESCRIPTION OF THE DRAWINGS

The present invention is described in detail with reference to the accompanying drawings.

FIG. 1 is a schematic exploded view of a connector with a self-locking function according to the present invention;

FIG. 2 is a schematic structural view of a connector with a self-locking function according to the present invention;

FIG. 3 is a schematic view of an interlocked structure of two connectors with the self-locking function according to the present invention;

FIG. 4 is a cross-sectional view of a connector with a self-locking function according to the present invention;

FIG. 5 is a schematic structural view of a valve body according to the present invention;

FIG. 6 is a perspective view of a valve body according to the present invention;

FIG. 7 is a bottom view of a valve body according to the present invention;

FIG. 8 is a schematic exploded view of a handle assembly according to the present invention;

FIG. 9 is a first schematic structural view of an inner knob block according to the present invention;

FIG. 10 is a second schematic structural view of an inner knob block according to the present invention;

FIG. 11 is a first schematic structural view of an outer knob block according to the present invention;

FIG. 12 is a second schematic structural view of an outer knob block according to the present invention;

FIG. 13 is a schematic structural view of a limiting assembly according to the present invention;

FIG. 14 is a schematic structural view of a valve core according to the present invention; and

FIG. 15 is a cross-sectional view of a valve core according to the present invention.

### LIST OF REFERENCE NUMERALS

1. valve body; 2. interlocking assembly; 3. handle assembly; 4. limiting assembly; 5. valve core; 6. tail end piece; 7. stabilizing assembly; 8. wire;

11. handle connector; 111. first mounting passage; 112. second mounting passage; 113. first limiting hole; 114. second limiting hole;

12. valve core stabilizer; 121. third mounting passage;

13. wire insertion port; 131. annular groove;

14. sealing ring;

21. connection slot; 22. hook-shaped protrusion;

31. inner knob block; 32. outer knob block; 33. bolt; 34. first magnetic ring; 35. second magnetic ring; 36. limiting screw; 37. first limiting pin;

311. protrusion; 321. arc-shaped groove; 313. limiting pin insertion port;

41. third magnetic ring; 42. second limiting pin; 421.iron block;

71. spring; and 72. sleeve.

### DETAILED DESCRIPTION OF THE EMBODIMENTS

To provide a clearer understanding of the technical problem to be solved, the technical solution, and the beneficial effects of the present invention, the following further detailed description is provided in conjunction with the accompanying drawings and embodiments. It is to be understood that the specific embodiments described herein are merely illustrative of the invention and are not intended to limit the present invention.

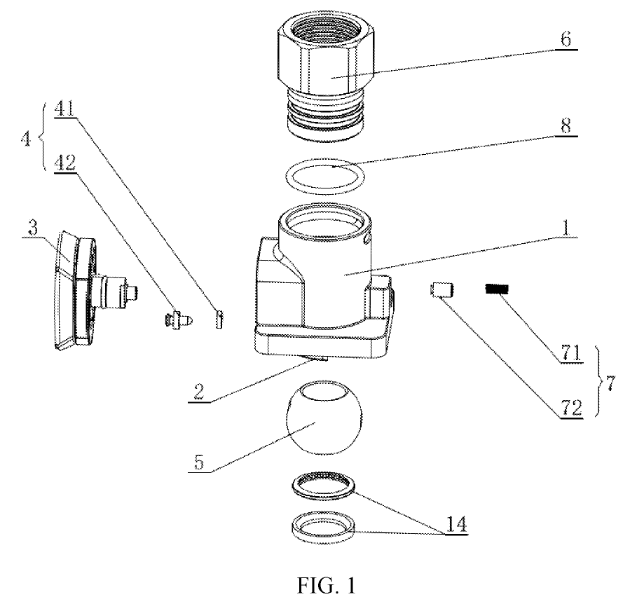

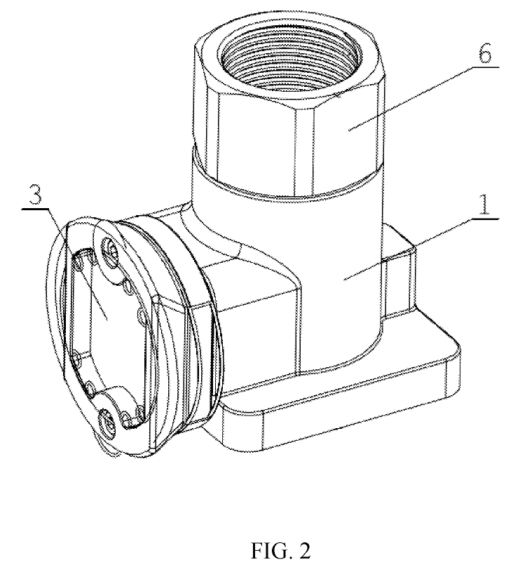

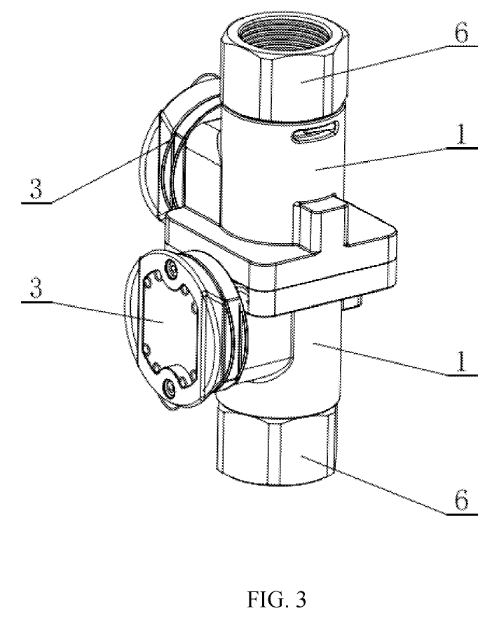

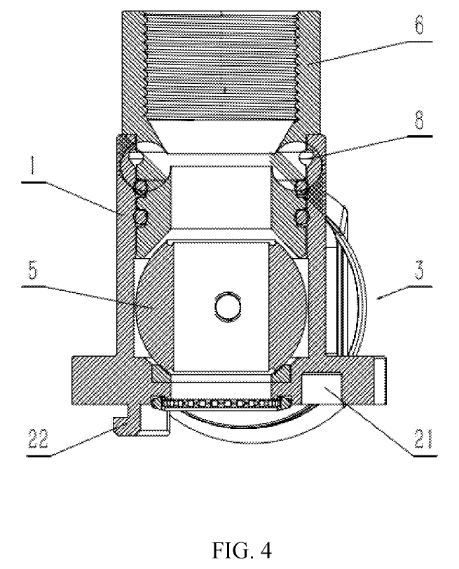

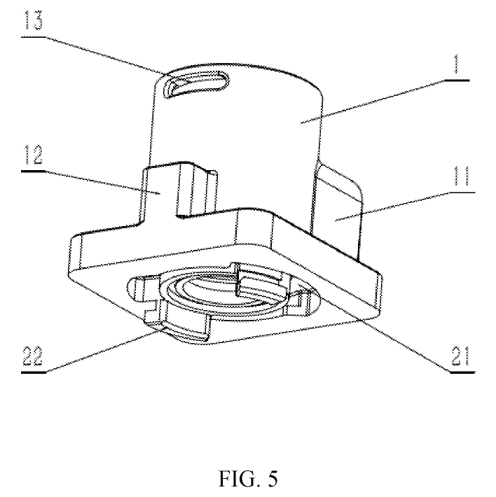

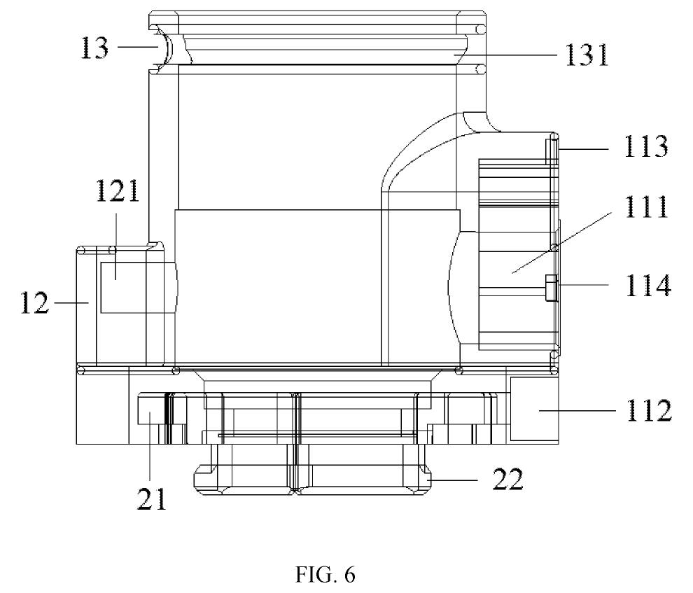

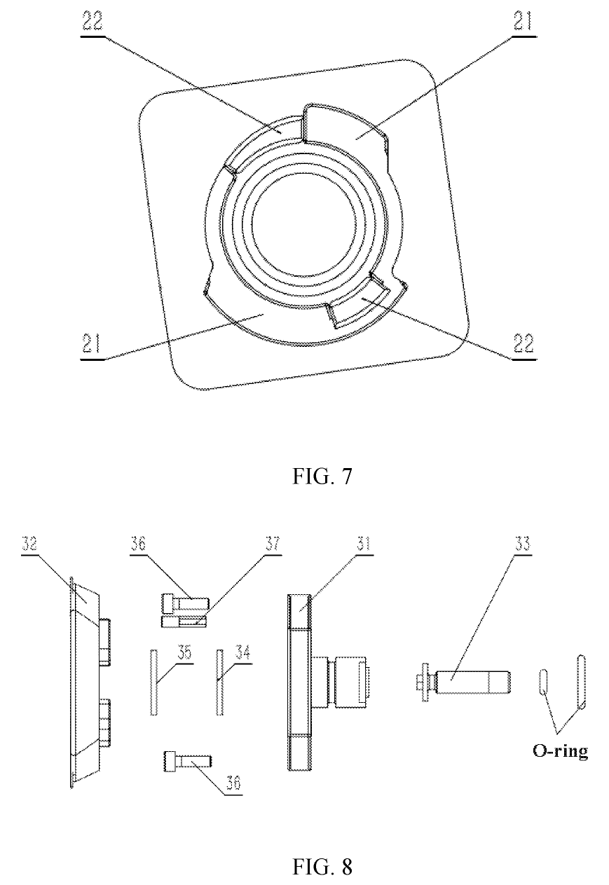

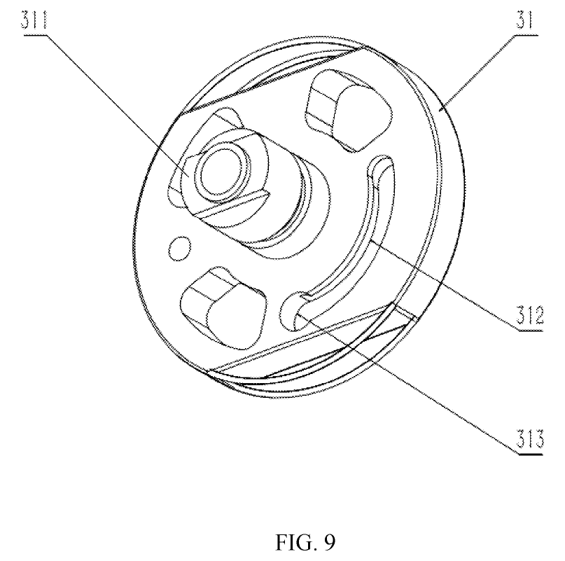

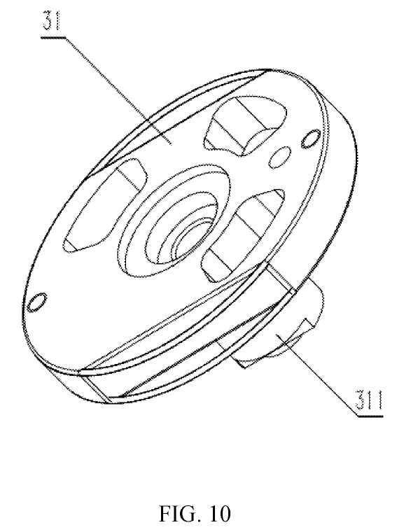

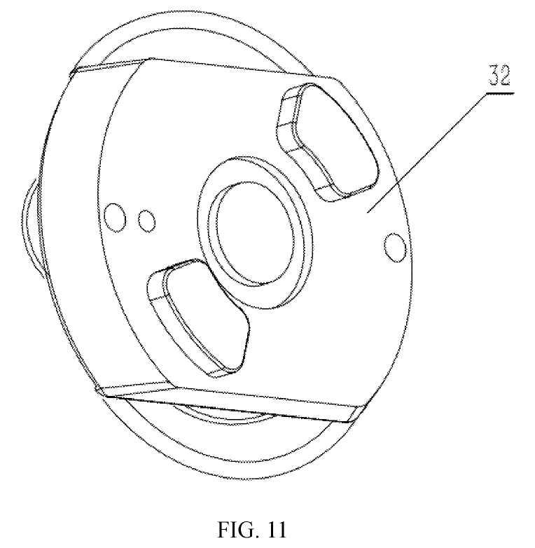

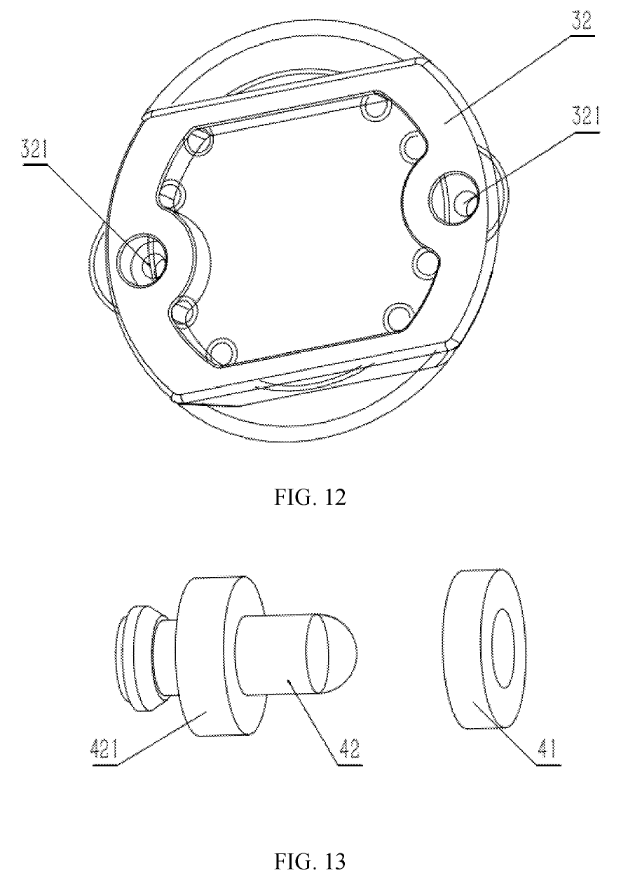

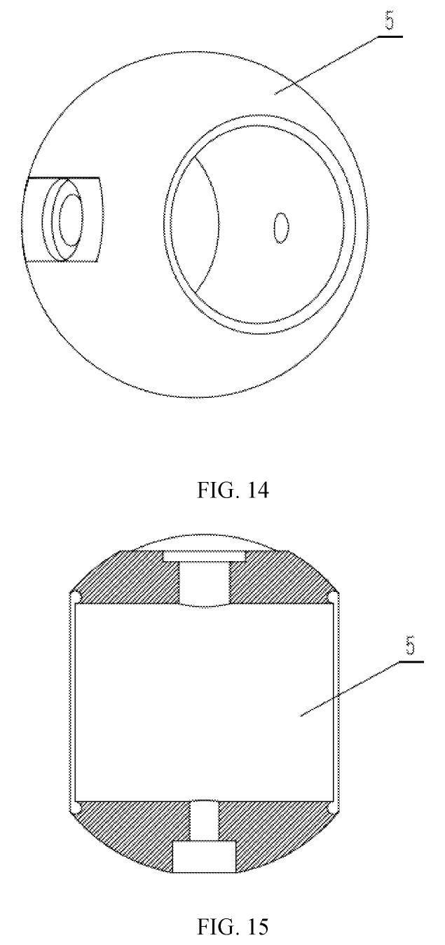

As shown in FIGS. 1-15, a connector with a self-locking function, including a valve body 1, wherein an interlocking assembly 2 is disposed at a bottom of the valve body 1, and two distinct valve bodies 1 are connected together via the interlocking assembly 2; a side wall of the valve body 1 is rotatably connected to a handle assembly 3, a limiting assembly 4 for limiting the handle assembly 3 is further disposed on the side wall of the valve body 1, and rotation of the handle assembly 3 drives rotation of a valve core 5 within the valve body 1; and a tail end piece 6 is rotatably connected to a top of the valve body 1.

Specifically, the interlocking assembly 2 includes a connection slot 21 and a hook-shaped protrusion 22, the connection slot 21 is formed at the bottom of the valve body 1, the hook-shaped protrusion 22 is integrally formed at the bottom of the valve body 1 and is located surrounding the connection slot 21, and the hook-shaped protrusion 22 and the connection slot 21 are configured to engage with each other.

Specifically, a handle connector 11 is integrally formed with the side wall of the valve body 1, the handle connector 11 is provided with a first mounting passage 111 and a second mounting passage 112, and a connection end of the handle assembly 3 passes through the first mounting passage 111 and is connected to the valve core 5; the second mounting passage 112 is in communication with the connection slot 21, and the limiting assembly 4 is installed within the second mounting passage 112;

a valve core stabilizer 12 is further integrally formed with the side wall of the valve body 1, a third mounting passage 121 is provided in the valve core stabilizer 12, the third mounting passage 121 is coaxial with the first mounting passage 111, and a stabilizing assembly 7 for stabilizing the valve core 5 is installed within the third mounting passage 121; and

the side wall of the valve body 1 is further provided with a wire insertion port 13, an inner wall of the valve body 1 is provided with an annular groove 131 for mounting a wire 8, the wire insertion port 13 corresponds to the annular groove 131, and the wire 8 is configured to limit the tail end piece 6.

Specifically, the handle connector 11 is further provided with a first limiting hole 113 and a second limiting hole 114 for limiting the handle assembly 3.

Specifically the handle assembly 3 includes an inner knob block 31 and an outer knob block 32, wherein a center of the inner knob block 31 is provided with a protrusion 311, a body of the protrusion 311 is rotatably disposed within the first mounting passage 111, and the protrusion 311 is snap-fit engaged with the valve core 5; a bolt 33 is threadedly connected to the inner knob block 31, and a body of the bolt 33 passes through a predrilled through hole at a center of the protrusion 311 and is threadedly connected to the valve core 5;

a first magnetic ring 34 is mounted on the inner knob block 31, a second magnetic ring 35 is mounted on the outer knob block 32, and the inner knob block 31 and the outer knob block 32 are magnetically coupled together via the two magnetic rings; the inner knob block 31 is provided with a limiting screw 36, and the other end of the limiting screw 36 is connected in a third limiting hole 321 of the outer knob block 32; and

a first limiting pin 37 is mounted on the outer knob block 32, the first limiting pin 37 corresponds to the first limiting hole 113 and the second limiting hole 114, respectively, and the inner knob block 31 is provided with a through hole for the first limiting pin 37 to pass through.

Specifically, the limiting assembly 4 includes a third magnetic ring 41 and a second limiting pin 42, the third magnetic ring 41 is adhered within the second mounting passage 112, an iron block 421 is mounted on a body of the second limiting pin 42, and the iron block 421 is magnetically attached to the third magnetic ring 41; and

the inner knob block 31 is provided with an arc-shaped groove 312, one end of the arc-shaped groove 312 is connected to a limiting pin insertion port 313, one end of the second limiting pin 42 is located within the connection slot 21, and the other end is partially embedded in the limiting pin insertion port 313, when two valve bodies 1 are connected together via the interlocking assembly 2, the hook-shaped protrusion 22 on one valve body 1 displaces the second limiting pin 42 on the other valve body 1 out of the connection slot 21. At this point, the end head portion of the second limiting pin 42 is fully embedded within the limiting pin insertion port 313.

Interlocking Principle: when operating a single connector with a self-locking function, that is, when connecting the tail end piece 6 on a single ball valve to a liquid flow passage, under the action of the third magnetic ring 41, the iron block 421 on the second limiting pin 42 is attracted to the third magnetic ring 41. At this point, the inner end side of the second limiting pin 42 is located in the connection slot 21, and the outer end side is partially embedded in the limiting pin insertion port 313. Consequently, the second limiting pin 42 is prevented from sliding within the arc-shaped groove 312. This configuration achieves the limiting effect of the second limiting pin 42 on the inner knob block 31, preventing the inner knob block 31 from rotating. As a result, the valve core 5 is maintained in a blocking state. This arrangement avoids liquid leakage caused by an operator erroneously rotating the handle assembly 3, thereby improving the safety of the connector with the self-locking function.

When two connectors with the self-locking function are interlocked, the hook-shaped protrusion 22 on one valve body 1 displaces the second limiting pin 42 on the other valve body 1 out of the connection slot 21, At this point, the end head portion of the second limiting pin 42 is fully embedded within the limiting pin insertion port 313, and the second limiting pin 42 is configured to slide within the arc-shaped groove 312, such that rotation of the handle assembly 3 by an operator permits fluid flow within the pipeline.

In a specific implementation, to facilitate the hook-shaped protrusion 22 displacing the second limiting pin 42 out of the connection slot 21, the abutment surface between the hook-shaped protrusion 22 and the second limiting pin 42 is configured as an arc-shaped surface. When two connectors with the self-locking function are rotationally interlocked, the hook-shaped protrusion 22 displaces the second limiting pin 42 out of the connection slot 21.

Specifically, the third magnetic ring 41 is replaced with a spring by a person skilled in the art. The spring is employed to connect to the iron block 421 and the second mounting passage 112, such that the spring provides the force required for resetting to the second limiting pin 42

Specifically, the stabilizing assembly 7 includes a spring 71 and a sleeve 72, the sleeve 72 is sleeved over the spring 71, one end of the spring 71 abuts against an inner wall of the third mounting passage 121, the other end of the spring abuts against the sleeve 72, a main body of the sleeve 72 is movably connected within the third mounting passage 121, and the sleeve 72 is rotatably connected to the valve core 5.

Specifically, two O-rings for sealing are connected to the tail end piece 6.

Specifically, an O-ring for sealing is sleeved over each of the protrusion 311 and the bolt 33.

Specifically, sealing rings 14 are mounted at the bottom of the valve body 1.

Wherein two sealing rings 14 are provided, one for sealing between the valve core 5 and the valve body 1, and the other for sealing between two different valve bodies 1.

The working principle of the connector with a self-locking function according to the present invention is as follows:

Interlocking Principle: when operating a single connector with a self-locking function, that is, when connecting the tail end piece 6 on a single ball valve to a liquid flow passage, under the action of the third magnetic ring 41, the iron block 421 on the second limiting pin 42 is attracted to the third magnetic ring 41. At this point, the inner end side of the second limiting pin 42 is located in the connection slot 21, and the outer end side is partially embedded in the limiting pin insertion port 313. Consequently, the second limiting pin 42 is prevented from sliding within the arc-shaped groove 312. This configuration achieves the limiting effect of the second limiting pin 42 on the inner knob block 31, preventing the inner knob block 31 from rotating. As a result, the valve core 5 is maintained in a blocking state. This arrangement avoids liquid leakage caused by an operator erroneously rotating the handle assembly 3, thereby improving the safety of the connector with the self-locking function.

When two connectors with the self-locking function are interlocked, the hook-shaped protrusion 22 on one valve body 1 displaces the second limiting pin 42 on the other valve body 1 out of the connection slot 21, At this point, the end head portion of the second limiting pin 42 is fully embedded within the limiting pin insertion port 313, and the second limiting pin 42 is configured to slide within the arc-shaped groove 312, such that rotation of the handle assembly 3 by an operator permits fluid flow within the pipeline.

Anti-mistake principle: when rotating the handle assembly 3, the outer knob block 32 is pulled outward, the outer knob block 32 drives the first limiting pin 37 to disengage from the first limiting hole 113 or the second limiting hole 114. At this point, the outer knob block 32 is rotated, the outer knob block 32 drives the inner knob block 31 to rotate, whereby the inner knob block 31 drives the valve core 5 to rotate. When the first limiting pin 37 is aligned with the second limiting hole 114 or the first limiting hole 113, the outer knob block 32 is released, and the outer knob block 32 is magnetically attracted to the inner knob block 31 by the magnetic force between the two magnetic rings. At this point, the first limiting pin 37 is inserted into the second limiting hole 114 or the first limiting hole 113, thereby completing the limiting of the handle assembly 3.

It is to be noted that, in this document, relationship terms such as ''first'', ''second'', and the like are used solely to distinguish one entity or operation from another entity or operation, without necessarily implying any actual such relationship or order between these entities or operations. Furthermore, the terms ''comprising', ''including'', or any variations thereof are intended to cover a non-exclusive inclusion, such that a process, method, article, or apparatus comprising a list of elements not only includes those elements, but also includes other elements not expressly listed or elements inherent to such process, method, article, or apparatus.

The above embodiments merely describe the preferred method of the present invention, and do not limit the scope of the present invention, on the premise of not departing from the design spirit of the present invention, all kinds of deformations and improvements made by ordinary technicians in this field to the technical scheme of the invention should be within the scope of protection determined by the claim of the present invention.

What is claimed is:

1. A connector with a self-locking function, comprising a valve body, wherein an interlocking assembly is disposed at a bottom of the valve body, and two distinct valve bodies are connected together via the interlocking assembly; a side wall of the valve body is rotatably connected to a handle assembly, a limiting assembly for limiting the handle assembly is further disposed on the side wall of the valve body, and rotation of the handle assembly drives rotation of a valve core within the valve body; and a tail end piece is rotatably connected to a top of the valve body;
the interlocking assembly comprises a connection slot and a hook-shaped protrusion, the connection slot is formed at the bottom of the valve body, the hook-shaped protrusion is integrally formed at the bottom of the valve body and is located surrounding the connection slot, and the hook-shaped protrusion and the connection slot are configured to engage with each other;
a handle connector is integrally formed with the side wall of the valve body, the handle connector is provided with a first mounting passage and a second mounting passage, and a connection end of the handle assembly passes through the first mounting passage and is connected to the valve core; the second mounting passage is in communication with the connection slot, and the limiting assembly is installed within the second mounting passage;
a valve core stabilizer is further integrally formed with the side wall of the valve body, a third mounting passage is provided in the valve core stabilizer, the third mounting passage is coaxial with the first mounting passage, and a stabilizing assembly for stabilizing the valve core is installed within the third mounting passage; and
the side wall of the valve body is further provided with a wire insertion port, an inner wall of the valve body is provided with an annular groove for mounting a wire, the wire insertion port corresponds to the annular groove, and the wire is configured to limit the tail end piece.

2. The connector with the self-locking function according to claim 1, wherein the handle connector is further provided with a first limiting hole and a second limiting hole for limiting the handle assembly.

3. The connector with the self-locking function according to claim 2, wherein the handle assembly comprises an inner knob block and an outer knob block, a center of the inner knob block is provided with a protrusion, a body of the protrusion is rotatably disposed within the first mounting passage, and the protrusion is snap-fit engaged with the valve core; a bolt is threadedly connected to the inner knob block, and a body of the bolt passes through a predrilled through hole at a center of the protrusion and is threadedly connected to the valve core;
a first magnetic ring is mounted on the inner knob block, a second magnetic ring is mounted on the outer knob block, and the inner knob block and the outer knob block are magnetically coupled together via the two magnetic rings; the inner knob block is provided with a limiting screw, and the other end of the limiting screw is connected in a third limiting hole of the outer knob block; and
a first limiting pin is mounted on the outer knob block, the first limiting pin corresponds to the first limiting hole and the second limiting hole, respectively, and the inner knob block is provided with a through hole for the first limiting pin to pass through.

4. The connector with the self-locking function according to claim 3, wherein the limiting assembly comprises a third magnetic ring and a second limiting pin, the third magnetic ring is adhered within the second mounting passage, an iron block is mounted on a body of the second limiting pin, and the iron block is magnetically attached to the third magnetic ring; and
the inner knob block is provided with an arc-shaped groove, one end of the arc-shaped groove is connected to a limiting pin insertion port, one end of the second limiting pin is located within the connection slot, and the other end is partially embedded in the limiting pin insertion port; when two valve bodies are connected together via the interlocking assembly, the hook-shaped protrusion on one valve body displaces the second limiting pin on the other valve body out of the connection slot, thereby, an end head portion of the second limiting pin is entirely embedded within the limiting pin insertion port.

5. The connector with the self-locking function according to claim 1, wherein the stabilizing assembly comprises a spring and a sleeve, the sleeve is sleeved over the spring, one end of the spring abuts against an inner wall of the third mounting passage, the other end of the spring abuts against the sleeve, a main body of the sleeve is movably connected within the third mounting passage, and the sleeve is rotatably connected to the valve core.

6. The connector with the self-locking function according to claim 1, wherein two O-rings for sealing are connected to the tail end piece.

7. The connector with the self-locking function according to claim 3, wherein an O-ring for sealing is sleeved over each of the protrusion and the bolt.

8. The connector with the self-locking function according to claim 1, wherein sealing rings are mounted at the bottom of the valve body.
